(19) United States
(12) Patent Application Publication
(10) Pub. No.: US 2014/0050414 A1
(43) Pub. Date: Feb. 20, 2014

(54) Encoder, Decoder and Methods Thereof for Texture Compression

(71) Applicants: Jacob Ström, Stockholm (SE); Per Wennersten, Arsta (SE)

(72) Inventors: Jacob Ström, Stockholm (SE); Per Wennersten, Arsta (SE)

(73) Assignee: TELEFONAKTIEBOLAGET L M ERICSSON (PUBL), Stockholm (SE)

(21) Appl. No.: 14/114,067

(22) PCT Filed: Oct. 18, 2011
(86) PCT No.: PCT/EP2011/068145

§ 371 Date: Oct. 25, 2013

Related U.S. Application Data
(60) Provisional application No. 61/480,681, filed on Apr. 29, 2011.

(51) Int. Cl. G06T 9/00

(52) U.S. Cl. CPC G06T 9/004
USPC 382/238

(57) ABSTRACT

The embodiments of the present invention relate to compression of parameters of an encoded texture block such that an efficient encoding is achieved. Index data is used as an example of parameters to be encoded. Accordingly, encoding the index data is achieved by predicting the index data, wherein the prediction is done in the pixel color domain, where changes often are smooth, instead of in the pixel index domain where the changes vary a lot. Hence, according to embodiments of the present invention the index data is predicted from previously predicted neighboring pixels taking into account that the base value and a modifier table value are known. When the index value is predicted the real index value can be decoded with the prediction as an aid. Since this way of predicting the index provides a very good prediction, it lowers the number of bits needed to represent the pixel index.

### TECHNICAL FIELD

The embodiments of the present invention relates to texture compression, and in particular to a solution for increasing the compression efficiency by encoding and decoding a parameter associated with at least one pixel of a texture block.

### BACKGROUND

Presentation and rendering of images and graphics on data processing systems and user terminals, such as computers, and in particular on mobile terminals have increased tremendously the last years. For example, graphics and images have a number of appealing applications on such terminals, including games, 3D maps and messaging, screen savers and man-machine interfaces.

However, rendering of textures, and in particular graphics, is a computationally expensive task in terms of memory bandwidth and processing power required for the graphic systems. For example, although textures reside in relatively large, off-chip DRAM memory, this is still limited and can run out of space. Furthermore, rendering directly from the off-chip DRAM-memory would be too slow, so textures must be transferred to fast on-chip memory before rendering takes place. The on-chip memory is typically referred to as a cache. This transfer of data between the off-chip memory and the cache is costly in terms of memory bandwidth between the DRAM chip and the rendering chip. A texture can be accessed several times to draw a single pixel.

In order to reduce the bandwidth and processing power requirements, an image (texture) encoding method or system is typically employed. Such an encoding system should result in more efficient usage of off-chip DRAM memory, expensive on-chip cache memory and lower memory bandwidth during rendering and, thus, in lower power consumption and/or faster rendering. This reduction in bandwidth and processing power requirements is particularly important for thin clients, such as mobile units and telephones, with a small amount of memory, little memory bandwidth and limited power (powered by batteries).

Accordingly, texture compression is an important component in modern graphics systems such as desktop PCs, laptops, tablets and phones. To summarize, it fills three main purposes:

Reduced Transport Time:

When an app is downloaded over the network, the use of compressed textures makes it possible to transfer more and higher-resolution textures while keeping the download time low. This is important for games for instance, where quick download/installation is important.

Reduced Memory Footprint:

Once the texture is transferred to the graphics DRAM memory of the device, it is possible to fit more or higher resolution textures in the memory. Furthermore, more pixels fit in the on-chip cache memory.

Reduced Memory Bandwidth:

By transferring the textures in compressed form between the GPU and the graphics memory, it is possible to lower the number of memory accesses (a.k.a. bandwidth), which increases rendering performance in frames per seconds and/or lowers battery consumption.

The requirement of transmission speed is increasing continuously, and it is therefore desired to provide a more efficient compression scheme. One example of a codec performing texture compression is referred to as ETC1 (Ericsson Texture Compression, version 1) which is further described in “iPACKMAN: High-Quality, Low-Complexity Texture Compression for Mobile Phones” by Jacob Strom and Tomas Akenine-Moller, Graphics Hardware (2005), ACM Press, pp. 63-70.

Today, ETC1 is available on many devices. For instance, Android supports ETC1 from version 2.2 (Froyo), meaning that millions of devices are running ETC1.

ETC1 was originally developed to be an asymmetric codec; decompression had to be fast, but compression was supposed to be done off-line and could take longer. However, recent developments have made it important to be able to compress an image to ETC 1-format very quickly.

For the ETC1 codec, one possible solution would be if it were possible to compress the ETC1 files for transport over the network, and then uncompress them after transfer.

The simplest way to compress the ETC1 texture files would be to zip them before transferring them over the network. Typically it is not possible to compress already compressed image data (such as JPEG) using ZIP, since the image compression method (such as JPEG) has already removed all the redundancy from the image file, and further zipping it does not make it smaller. This does not apply to texture compression though: Due to random access requirements in the rendering process, texture compression formats must be fixed rate. This means that there is a lot of redundancy left in the ETC1 files.

Just zipping the ETC1 files does not work well enough, however. When compressing 64 textures using Window's built-in zip-functionality, the result turned out to be quite bad: The average file went down from 4 bits per pixels (bpp) to around 2.9 bpp. Worse, when investigating the textures it was found that many of them consisted of an object in front of a white background. White background is exactly the type of data that zip should work very well on. After removing these images from the test, the average bit rate was a disappointing 3.0 bpp. Other zip-like methods such as LZMA are more efficient than zip but still leads to 2.8 bpp, which is still high.

The main problem is that half of the data in ETC1 consists of index data, which happens to be very hard to compress. In short, ETC1 makes it possible for every pixel to select one of four colors, and this choice is stored in a pixel index. Unfortunately the pixel indices vary wildly even in areas that are very smooth, as can be seen in FIG. 1. The left image in FIG. 1 is a compressed image, the middle image is a zoom-in of a smooth part of the texture and the right image shows the pixel indices. It can be seen in the right image that the pixel indices contain a lot of variation even though the variation of the pixel colors is smooth. This makes the pixel indices hard to predict, and thus expensive to compress.

### SUMMARY

An object of embodiments of the present invention is to find a way to efficiently encode, i.e. compress, parameters of an encoded texture block to achieve an efficient encoding. In the following described embodiments, index data is used as an example of parameters to be encoded.

According to a first aspect of embodiments of the present invention, a method in an encoder for encoding a parameter associated with at least one pixel of a texture block to be encoded is provided. In the method, the value of at least one pixel in an area of the texture block to be encoded that is affected by the parameter is predicted by using at least one previously encoded pixel and at least two settings of the parameter to be encoded are selected. For each of the at least two settings of the parameter, a difference measure between said predicted value of said at least one pixel and a value representing said at least one pixel is calculated as if the at least one pixel would have been encoded and decoded with the setting of the parameter by using at least one previously transmitted additional parameter. Further, the setting of the parameter is selected that minimizes said difference measure, and the selected setting of said parameter is used to encode said parameter.

According to a second aspect of embodiments according to the present invention, a method in a decoder for decoding a parameter associated with at least one pixel of a texture block to be decoded is provided. In the method, a value of at least one pixel in an area of the texture block to be decoded that is affected by the parameter is predicted by using at least one previously decoded pixel, and at least two settings of the parameter to be decoded are selected. For each of the at least two settings of the parameter, a difference measure is calculated. The difference measure is a difference between said predicted value of said at least one pixel and a value representing said at least one pixel as if the at least one pixel would have been encoded and decoded with the setting of the parameter by using at least one previously transmitted additional parameter. Further the setting of the parameter that minimizes said difference measure is selected, and the selected setting of said parameter is used to decode said parameter.

According to a third aspect of embodiments according to embodiments of the present invention an encoder for encoding a parameter associated with at least one pixel of a texture block to be encoded is provided. The encoder comprises a processor configured to predict a value of at least one pixel in an area of the texture block to be encoded that is affected by the parameter by using at least one previously encoded pixel, and to select at least two settings of the parameter to be encoded, to calculate, for each of the at least two settings of the parameter, a difference measure between said predicted value of said at least one pixel and a value representing said at least one pixel as if the at least one pixel would have been encoded and decoded with the setting of the parameter by using at least one previously transmitted additional parameter. The processor is further configured to select the setting of the parameter that minimizes said difference measure, and to use the selected setting of said parameter to encode said parameter.

According to a fourth aspect of embodiments according to embodiments of the present invention a decoder for decoding a parameter associated with at least one pixel of a texture block to be decoded is provided. The decoder comprises a processor configured to predict a value of at least one pixel in an area of the texture block to be decoded that is affected by the parameter by using at least one previously decoded pixel, and to select at least two settings of the parameter to be decoded. The processor is further configured to calculate, for each of the at least two settings of the parameter, a difference measure. The difference measure is a difference between said predicted value of said at least one pixel and a value representing said at least one pixel as if the at least one pixel would have been encoded and decoded with the setting of the parameter by using at least one previously transmitted additional parameter. The processor is further configured to select the setting of the parameter that minimizes said difference measure, and to use the selected setting of said parameter to decode said parameter.

According to further aspects, a mobile device is provided. The mobile device comprises an encoder according to one aspect and the mobile device comprises a decoder according to a further aspect.

Accordingly, encoding the index data is achieved by predicting the index data, wherein the prediction is done in the pixel color domain, where changes often are smooth, instead of in the pixel index domain where the changes vary a lot.

Hence, according to embodiments of the present invention the index data is predicted from previously predicted neighboring pixels taking into account that the base value and a modifier table value are known. It should be noted that the base value and the modifier table value in this case correspond to the previously transmitted additional parameters.

When the index value, the modifier table value is predicted the real index value can be encoded/decoded with the prediction as an aid. Since this way of predicting the index provides a very good prediction, it lowers the number of bits needed to represent the pixel index.

An advantage of embodiments of the invention is that they allow lowering the transfer rate of textures when downloading them over a network or reading them from a disk/flashdrive. Once this transfer is done, the textures can be decompressed into the ETC1 format and can then be sent to the graphics hardware. Alternatively, they can be first sent to the graphics hardware memory, and the GPU can then decompress them to ETC1 format before rendering. This way the transfer over the memory bus between the CPU and the GPU is also made more efficient.

Another advantage of embodiments of the present invention is that the textures may reside in compressed form on the device, and thus not occupy so much system resources. When the application is started, the textures can be decompressed into ETC1 format.

Yet another advantage of embodiments of the present invention is that they can be made to work also for other texture compression codecs, such as S3TC and of course even PVR-TC. Since ETC2 is backwards compatible with ETC1, it even works for ETC2 without modifications, albeit at a worse bit rate. However, it is no problem to adapt the embodiments to ETC2.

A further advantage is that embodiments of the present invention improve the transport time.

### BRIEF DESCRIPTION OF THE DRAWINGS

FIG. 1: The left image in FIG. 1 is a compressed image, the middle image is a zoom-in of a smooth part of the texture and the right image shows the pixel indices.

FIG. 2: A flowchart illustrating the method in an encoder according to embodiments of the present invention is shown in FIG. 2.

FIG. 3: A flowchart illustrating the method in an encoder according to embodiments of the present invention is shown in FIG. 3.

FIG. 4: It is illustrated in FIG. 4 that ETC1 compresses 4×4 blocks by treating each of them as two half blocks. Each half block gets a “base color”, and then the luminance (intensity) can be modified in the half block.

FIG. 5: It is illustrated in FIG. 5 that predicting the current pixel from another may not work well if they are uncorrelated.

FIG. 6: It is illustrated in FIG. 6, that it is advantageous to predict the color of a pixel from the color of a neighboring pixel.

FIGS. 7 and 8 illustrate the process of encoding the parameter, the modifier table value, according to an embodiment of the present invention.

FIG. 9 illustrates an encoder and a decoder according to embodiments of the present invention.

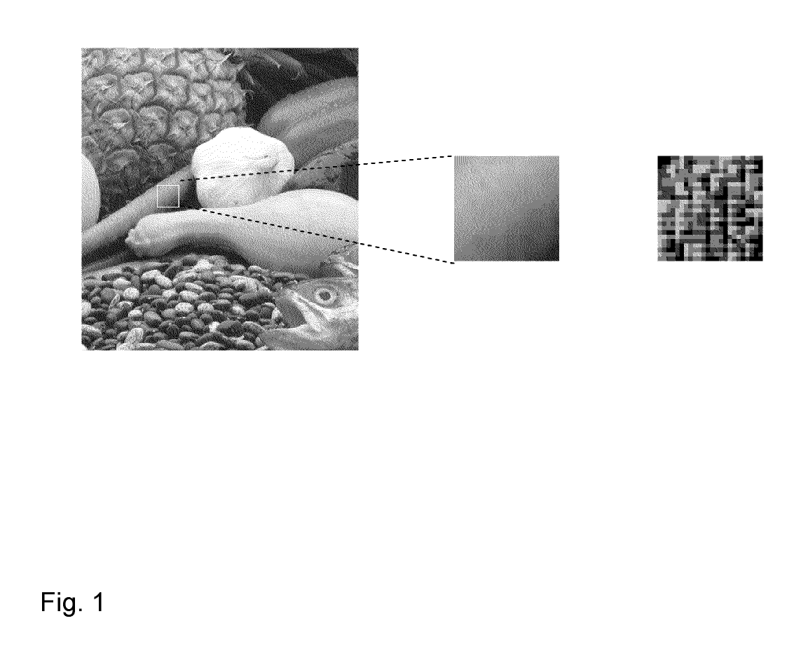

### DETAILED DESCRIPTION

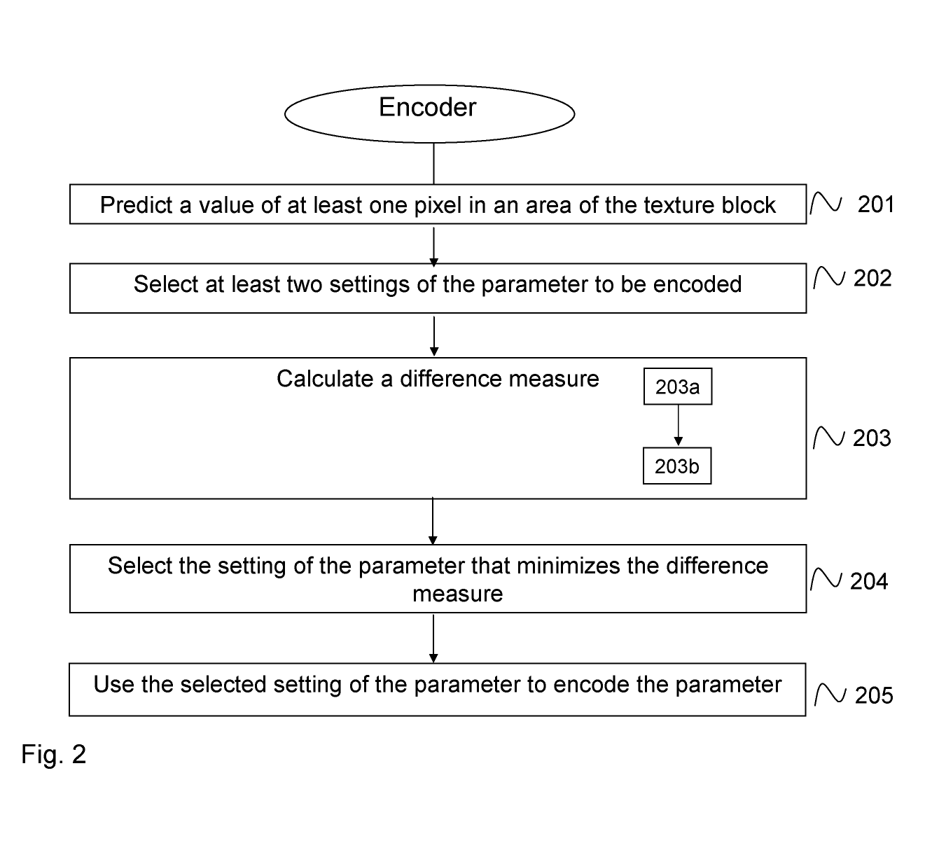

The embodiments of the present invention relates to compression of texture blocks. The compression is achieved by encoding/decoding a parameter associated with at least one pixel of a texture block to be encoded/decoded. The parameter is in one embodiment exemplified by a pixel index. In the encoding example as illustrated in the flowchart of FIG. 2, a value of at least one pixel in an area of the texture block to be encoded that is affected by the parameter is predicted 201 by using at least one previously encoded pixel. Then, at least two settings of the parameter to be encoded are selected 202, which imply that two different values to be used for encoding the parameter are selected. It should be noted that the value of the at least one pixel may comprise a vector of red, green and blue-components in case of color pixels.

For each of the at least two settings of the parameter a difference measure is calculated 203 by using at least one previously transmitted additional parameter. The difference measure represents the difference between said predicted value of said at least one pixel and a value representing said at least one pixel as if the at least one pixel would have been encoded and decoded with the selected setting of the parameter. The value representing said at least one pixel as if the at least one pixel would have been encoded and decoded with the setting of the parameter is a value that can be calculated either by estimating the value or by encoding said at least one pixel with one of the at least two settings of the parameter and decoding said at least one pixel with one of the at least two settings of the parameter to get to get value 203a.

Then the setting of the parameter that minimizes said difference measure is selected 204 and the selected setting of said parameter is used 205 to encode said parameter.

According to some embodiments, said parameter is a pixel index and the at least one previously transmitted additional parameter comprises at least one base color and at least one modifier table value.

Furthermore, said difference measure may be a summed squared difference or a summed absolute difference.

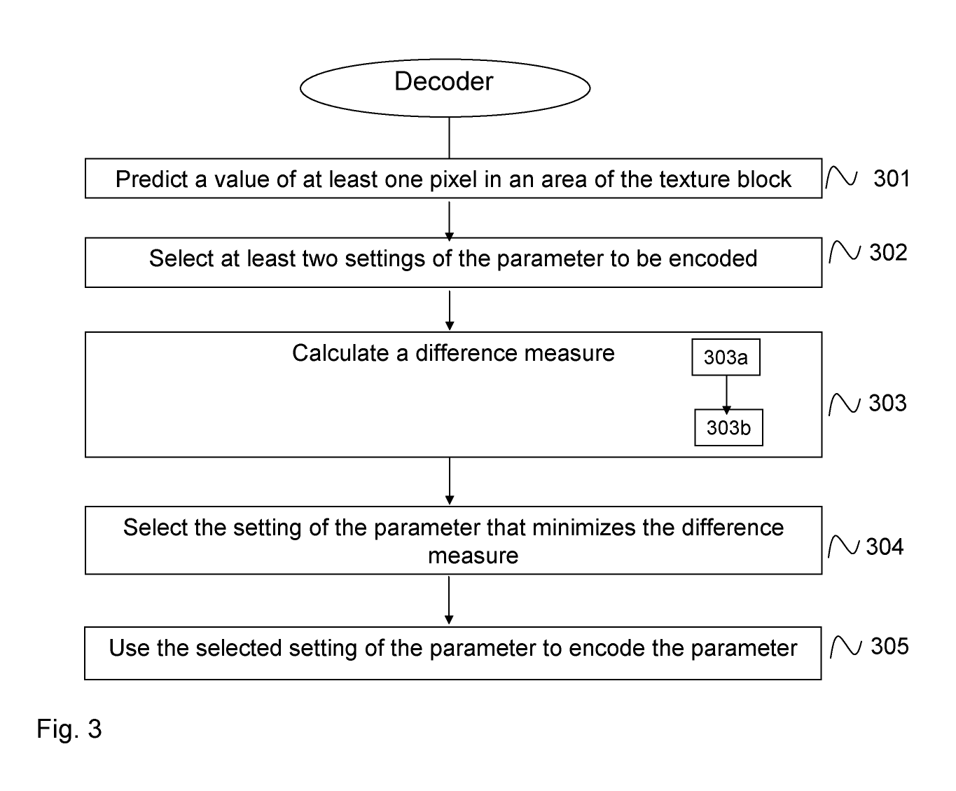

In the decoding example as illustrated in the flowchart of FIG. 3, a value of at least one pixel in an area of the texture block to be decoded that is affected by the parameter is predicted 301 by using at least one previously decoded pixel. At least two settings of the parameter to be decoded are selected 302. Further, for each of the at least two settings of the parameter a difference measure is calculated 303. The difference measure represents a measure between said predicted value of said at least one pixel and a value representing said at least one pixel as if the at least one pixel would have been encoded and decoded with the setting of the parameter by using at least one previously transmitted additional parameter. In one embodiment, the step of calculating the difference measure comprises encoding 303a and decoding 303b said at least one pixel with one of the at least two settings of the parameter to get a value representing said at least one pixel by using at least one previously transmitted additional parameter.

Then the setting of the parameter is selected 304 that minimizes said difference measure, and the selected setting of said parameter is used 305 to decode said parameter.

As in the encoding described above, said parameter is a pixel index in one embodiment. Further, the at least one previously transmitted additional parameter may comprise at least one base color and at least one modifier table value.

In another embodiment, said parameter is a modifier table value and the at least one previously transmitted additional parameter may comprise flip bit information and base color.

Furthermore, said difference measure may be a summed squared difference or a summed absolute difference.

Prediction of the parameter exemplified by the pixel index will be described below.

Accordingly, an efficient compression is provided by predicting a pixel index indicative of luminance information instead of coding and decoding the pixel index directly. Furthermore, the base color of a pixel to be coded/decoded and a modifier table value describing which table to use to map pixel indices to modifier values are known, A color of said pixel is predicted based on at least one neighboring pixel which previously is coded/decoded.

The pixel index is predicted as the pixel index value that, together with the determined base color and the determined modifier table, produces a color closest to the predicted color.

Thus, the modifier table value indicates which modifier table to use and the modifier table value may be a value from 0-7. The modifier table is a table comprising four items which is identified by a pixel index.

The embodiments are described in the context of an ETC1 codec. Therefore, to understand how the embodiments work in detail, the function of the ETC1 codec is described below. It should however be noted that the embodiments are not limited to ETC1, the embodiments are also applicable on other compression methods such as DXTC (DirectX texture compression), PVRTC (PowerVR texture compression) and any other texture compression format.

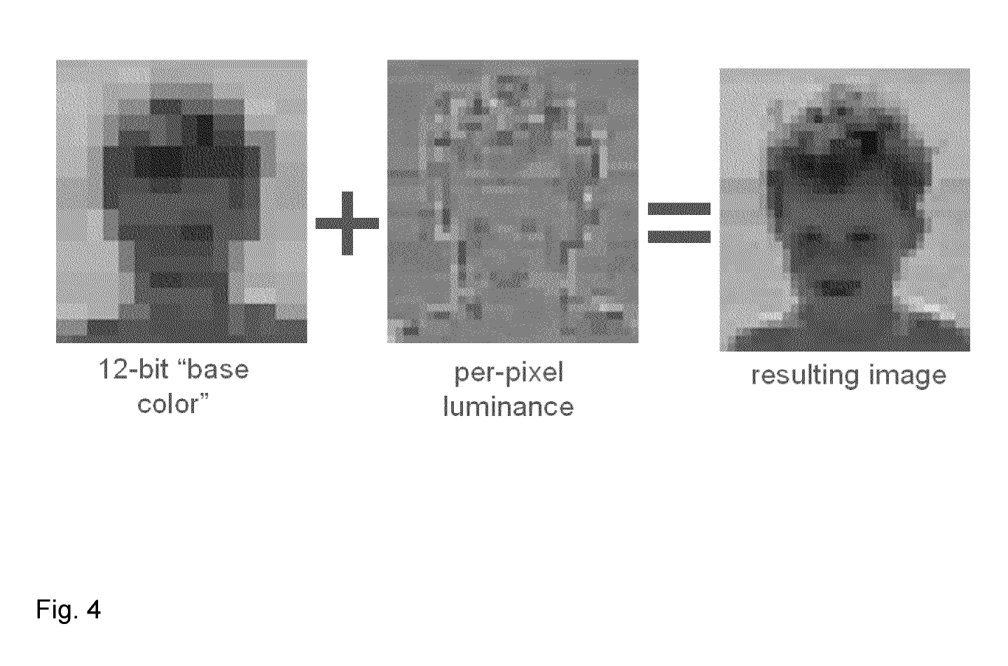

ETC1 compresses 4×4 blocks by treating each of them as two half blocks. Each half block gets a “base color”, and then the luminance (intensity) can be modified in the half block. This is illustrated in FIG. 4.

The left image of FIG. 4 is divided into blocks that are further divided into half blocks that are either lying or standing. Only one base color per half block is used. In the middle image, per pixel luminance is added and the right image shows the resulting image.

The luminance information is added in the following way: First one out of eight modifier tables is selected. Each modifier table comprises 4 items (such as −8, −2, 2, 8 as in table 0), wherein each item is identified by a pixel index (e.g. 0, 1, 2 3) and each modifier table is identified by a table number referred to as a modifier table value (e.g. 0-7). Examples of possible tables are:

### Table 0: {−8, −2, 2, 8}

### Table 1: {−17, −5, 5, 17}

### Table 2: {−29, −9, 9, 29}

### Table 3: {−42, −13, 13, 42}

### Table 4: {−60, −18, 18, 60}

### Table 5: {−80, −24, 24, 80}

### Table 6: {−106, −33, 33, 106}

### Table 7: {−183, −47, 47, 183}

The modifier table value is stored in the block using a 3-bit index and the pixel indices are stored in a block using a 2-bit pixel index making it possible to select one of the four items in the table.

Assume for instance that the base color is (R, G, B)=(173, 200, 100) and table 4 is selected. Assume that a pixel has a pixel index of 11 binary, i.e., the last item in the table should be selected. The color of the pixel is then calculated as

(173,200,100)+(60,60,60)=(233,260,160),

which is then clamped to the range [0, 255] to the color (233, 255, 160).

It will now first be described how the prediction of the index data is done in the pixel index domain and then how it is done according to the embodiments in the pixel domain.

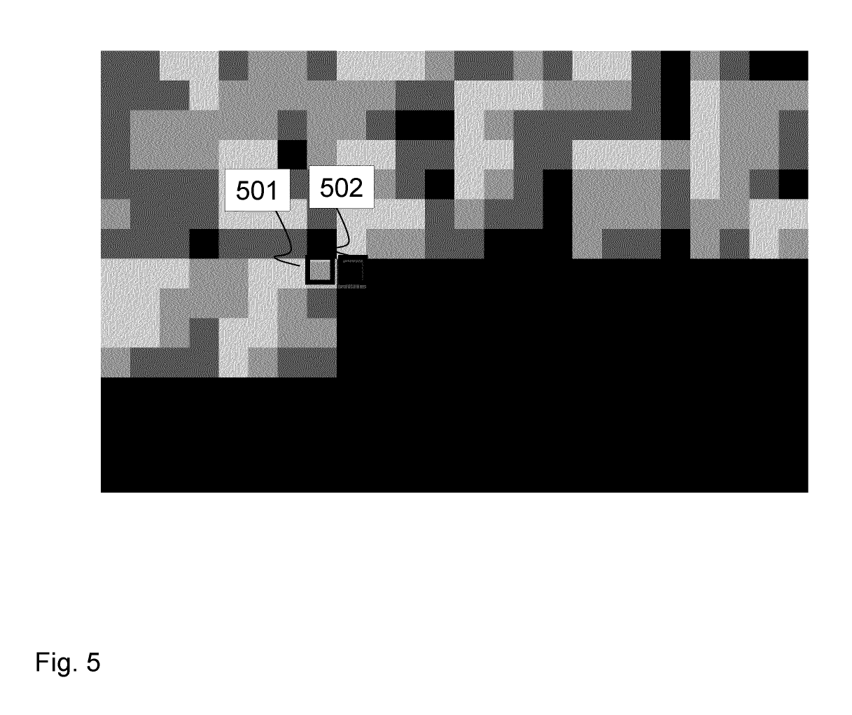

FIG. 5 illustrates that predicting the current pixel 502 from the one to the left 501 does not work well since they are quite uncorrelated.

Accordingly, FIG. 5 illustrates the index data for different pixels. The values of the index data may be 0, 1, 2 or 3, indicating the first, second, third or fourth items in one of the tables, where 0 is illustrated in FIG. 5 using black, 1 is illustrated with dark gray, 2 is illustrated with brighter gray and 3 is illustrated with even brighter gray. Now if the embodiments are applied in an encoder, all the pixel indices to the left and above are already coded, and the pixel index marked with 502 should be encoded. One way to do that is to assume that the pixel index will be the same as the one directly to its left, marked with 501. Assume the left pixel index has value 2 (10 binary) as in FIG. 5. If all the indices are analyzed and a frequency table is made out of all pixels indices whose left neighbor has a value of 2, the result may be:

Current value:

| | 0 | 1 | 2 | 3 |
|---|---|---|---|---|
| Percentage: | 16% | 22% | 38% | 23% |

This means that it is more likely that the pixel index will be 2 (38%) if it is preceded by a pixel index of value 2, than any other value. The entropy of this distribution is:

$$\begin{matrix}H ( p ) = {\sum }_{k = 0}^{a} - p ( k ) {log}_{2} ( p ( k ) ) \\ = - 0.16 * {log}_{2} ( 0.16 ) - 0.22 * {log}_{2} ( 0.22 ) - \\ 0.38 * {log}_{2} ( 0.38 ) - 0.23 * {log}_{2} ( 0.23 ) \\ = 1.92 .\end{matrix}$$

This means that, on average, it would require 1.92 bits to compress a pixel index. That is not much better than the two bits that would be required if we just stored the pixel index without compression.

As seen in FIG. 5, there is much variability in the pixel index data. Thus it is difficult to find a good way to predict pixel indices from previous pixel indices. However, according to embodiments of the present invention it is realized that it is much easier to predict pixel colors from previous pixel colors.

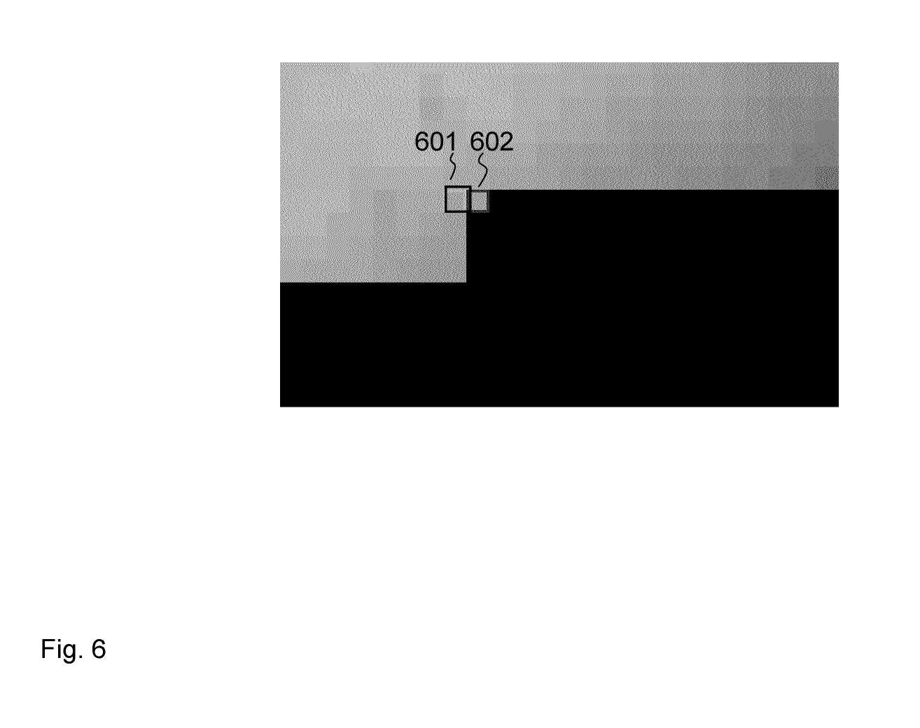

It is illustrated in FIG. 6, that it is advantageous to predict the color of a pixel from that of a neighboring pixel. Therefore in accordance with embodiments of the invention, the idea is to predict the color of the pixel in the current pixel, and then finding the pixel index that best reproduces this predicted color. The thus found pixel index is now the prediction for the pixel index in the current position.

Now, embodiments of the present invention wherein the pixel index of the modifier table is predicted from the pixel domain will be described. Consider the prediction in FIG. 6, which corresponds to the same area that is depicted in FIG. 5. The example below describes the procedures in a decoder, but corresponding procedures can also be implemented in an encoder.

First, assume that the color in the pixel denoted 601 has color RGB=(249, 150, 26). According to the embodiments, the color of the pixel of interest denoted 602 is then predicted to have the same value: color_pred_RGB=(249, 150, 26). It should be noted that more than one previously decoded pixel may be used for predicting the color of the pixel of interest. Further, the base color of the half block is also known, since the base color is already transmitted from the encoder to the decoder and is decoded. Assume that the base color is (240, 130, 0).

Moreover, it is also known which modifier table that was used since this information has also already been decoded. Thus the encoder has transmitted information regarding which modifier table to use to the decoder. Assume that modifier table number 4 is being used, having the following four possible items: {−60, −18, 18, 60}.

To predict which item to use, and hence which index to use, at least one neighboring pixel which is previously decoded, the determined base color and the modifier table are used: The at least one neighboring pixel denoted 601 has color RGB=(249, 150, 26) and the color of the pixel of interest is assumed to have the same value as exemplified above. This is the prediction of the color in the current pixel.

To find the pixel index with the highest likelihood of producing the predicted color, the four possible colors are calculated that could come out of that pixel by trying all four pixel indices for the determined modifier table.

Pixel index 0 would mean table entry −60 which would produce the color

base_color+(−60−60−60)=(240−60,130−60,0−60)=(180,70,−60)

after clamping to values between 0 and 255, the result would be (180, 70, 0).

Likewise, a pixel index of 1 would produce (240−18, 130−18, 0−18)=(222, 112, 0) after clamping. Doing this for all four pixel indices would give:

Pixel index 0: (180, 70, 0)
Pixel index 1: (222, 112, 0)
Pixel index 2: (255, 148, 18)
Pixel index 3: (255, 190, 60)

It is now possible to compare these four colors against the predicted color, which is (249, 150, 26). It can immediately be seen that pixel index 2 produces the color closest to the predicted color. In more detail, the summed square error between the four candidate colors and the predicted color can be calculated:

Pixel index 0: Error=(180−249)²+(70−150)²+(0−26)²=11837

Pixel index 1: Error=(222−249)²+(112−150)²+(0−26)²=2 849

Pixel index 2: Error=(255−249)²+(148−150)²+(18−26)²=104

Pixel index 3: Error=(255−249)²+(190−150)²+(60−26)²=2792

That results in that pixel index 2 gives by far the smallest error between the predicted color and the calculated color. Hence 2 is the prediction of the pixel index for the current pixel. Another way to read this error table is that the error 11837 is the difference between the predicted color and the color that would have been obtained should the pixel have been compressed and decompressed with the pixel index parameter set to 0.

In some embodiments it may be enough to approximate the error value rather than implementing it exactly. This can be done by skipping over some of the steps. For instance, it is possible to simplify the above calculations by avoiding to clamp the result to the interval [0, 255]. In that case pixel index 2 would generate the color (240+18, 130+18, 0+18)=(258, 148, 18) instead of (255, 144, 18) and the pixel index error would be 149 instead of 104. Likewise, pixel index 3 would generate the color (300, 190, 60) which would generate an error of 5357. Even with these approximate errors, pixel index 2 would still be the smallest one and selected for prediction. Note that the same approximation must be done in both the encoder and the decoder.

Continuing with the example in conjunction with FIG. 6, if we go through the image and find all the places where the predicted index is 2, that might result in the following distribution:

Current value:

| | 0 | 1 | 2 | 3 |
|---|---|---|---|---|
| Percentage: | 6% | 12% | 68% | 13% |

From this it can be derived that the prediction is much better—more than two thirds of the time the prediction will be correct. The entropy for this distribution is:

$$\begin{matrix}H ( p ) = {\sum }_{k = 0}^{a} - p ( k ) {log}_{2} ( p ( k ) ) \\ = ( - 0.06 * ln ( 0.06 ) - 0.12 * ln ( 0.12 ) - \\ 0.68 * ln ( 0.68 ) - 0.13 * ln ( 0.13 ) ) / ln ( 2 ) = \\ = 1.37\end{matrix}$$

This means that, on average, the average bit rate will be around 1.37 bits per index, which is a huge step down from 1.92.

It turns out that the prediction is also improved when our method predicts 0, 1 or 3. However, four different prediction contexts may be used, one for each prediction. Thus, if the predicted index is 0, the following model distribution may be used.

Current value:

| | 0 | 1 | 2 | 3 |
|---|---|---|---|---|
| Percentage: | 65% | 15% | 12% | 8% |

If the predicted index is 1, the following model distribution may be used.

Current value:

| | 0 | 1 | 2 | 3 |
|---|---|---|---|---|
| Percentage: | 9% | 71% | 12% | 8% |

If the predicted index is 3, the following model distribution may be used.

Current value:

| | 0 | 1 | 2 | 3 |
|---|---|---|---|---|
| Percentage: | 9% | 11% | 12% | 68% |

An adaptive arithmetic coder can be used to encode the data using the different distributions as contexts, with good results. For instance, if the predicted pixel index is 0, a context in the arithmetic coder/decoder that holds the probability distribution [65%, 15%, 12%, 8%] is used to encode the current pixel index with the arithmetic coder. However, if the predicted pixel index is 1, the following distribution [9% 71% 12% 8%] can be used. Likewise, if the predicted index is 2, the context with the distribution [6% 12% 68% 13%] is used, and if the predicted index is 3, the context with the distribution [9% 11% 12% 68%] is used. Note that if the quality of our prediction is good, the distributions will contain one sharp peak around the predicted value. Such a distribution has low entropy and will result in an efficient encoding by the arithmetic coder. Making sure that all four distributions contain sharp peaks thus gives an efficient encoding for all four possible pixel index values 0, 1, 2 and 3.

Note that the percentages in these probability distributions are just examples. In a real implementation it is wise to estimate these probabilities from the data itself. Typically there is a trade-off to how many contexts should be used when encoding. Using many contexts, such as in the above example, typically generates efficient coding in the steady-state, when the probability distribution estimates have converged for all contexts. On the other hand, having many contexts means that it will take longer time for each of them to converge. Before convergence, the probability estimates will be wrong, and the encoding less efficient. In addition, each context takes up memory, which under certain circumstances can be a constraint. Hence there are also arguments for having fewer contexts. This is also possible with the embodiments of the present invention. One possibility is to calculate the difference between the predicted and actual index using just one prediction context. As an example, the probability distribution for that context may then be:

| | Difference: | | | | | | |
|---|---|---|---|---|---|---|---|
| | −3 | −2 | −1 | 0 | 1 | 2 | 3 |
| Percentage: | 4% | 6% | 8% | 64% | 8% | 6% | 4% |

For instance, if the actual pixel index is 2, and the predicted pixel index is 3, the encoder must perform the difference operation 2−3=−1. This difference is encoded with the arithmetic encoder using the probability distribution above. On the decoder side, the prediction value 3 is also known. The arithmetic decoder decodes the difference value −1, and the actual value can be calculated as the predicted value plus the difference value=3+(−1)=2. Hence the decoder can recover the actual value.

Note however, that since the number of possible values have risen from 4 (0 . . . 3) to 7 (−3 . . . 3), it will be harder to get a large peak in the distribution. This will lead to a higher rate in the long run. The entropy of the diagram above is calculated as

$$\begin{matrix}H ( p ) = {\sum }_{k = 0}^{a} - p ( k ) {log}_{2} ( p ( k ) ) \\ = ( - 0.04 * ln ( 0.04 ) - 0.06 * ln ( 0.06 ) - 0.08 * ln ( 0.08 ) - \\ 0.64 * ln ( 0.64 ) - 0.08 * ln ( 0.08 ) - 0.06 * ln ( 0.06 ) - \\ 0.04 * ln ( 0.04 ) ) / ln ( 2 ) = \\ = 1.85\end{matrix}$$

This would hence be much less efficient than using multiple contexts in the long run.

Another way to use fewer contexts is to use the same (but mirrored versions of the) context for 0 and 3, and another one for 1 and 2.

In more detail, it is desirable to use the same probability distribution for the two cases when the prediction is 0 and when it is 3. As shown above, these probability distributions are quite different:

If the predicted index is 0, the following model distribution was used:

Current value:

| | 0 | 1 | 2 | 3 |
|---|---|---|---|---|
| Percentage: | 65% | 15% | 12% | 8% |

If the predicted index is 3, the following model distribution was used.

Current value:

| | 0 | 1 | 2 | 3 |
|---|---|---|---|---|
| Percentage: | 9% | 11% | 12% | 68% |

Using the same probability distribution estimate for both 0 and 3 as is would just generate a combined probability distribution that is roughly the average of the two (exactly if they are equally probable), namely

Current value:

| | 0 | 1 | 2 | 3 |
|---|---|---|---|---|
| Percentage: | 37% | 13% | 12% | 38% |

However, this probability distribution would not be desirable, since it does not have any clear peak. The entropy of is now

H(p)=−(0.37*ln(0.37)+0.13*ln(0.13)+0.12*ln(0.12)+0.38*ln(0.38))/ln(2)=1.81,

which is quite high. Instead, the data is mirrored if the prediction is 2 or 3 in the encoder prior to arithmetic encoding. In that case, both the prediction and the actual value undergoes mirroring according to the following table:

Original value:

| | 0 | 1 | 2 | 3 |
|---|---|---|---|---|
| Mirrored value: | 3 | 2 | 1 | 0 |

The term mirroring is used since the second row of the table above is the same as the first row mirrored around its middle.

As an example, assume the predicted value is 3, and that the actual value is 2. Since the predicted value is larger than 1, the encoder mirrors it from 3 to 0 according to the table above. Then it also mirrors the actual value from 2 to 1 using the same table. The arithmetic encoder then encodes the value 1 using the prediction 0. The decoder also knows that the predicted value is 3. Since this is larger than 1, it is mirrored from 3 to 0. The arithmetic decoder now decodes the actual value using the prediction 0. The answer is 1, which is correct since this is what was encoded by the arithmetic encoder. Since the predicted value originally was larger than 1, the decoder mirrors this result from 1 to 2. The actual value of 2 has hence been correctly recovered.

This means that a prediction of 0 and 3 will share the same context, since 3 will be mirrored to 0. The probability distribution estimated for that context will roughly be an average of the probability distribution for 0 and the mirrored probability distribution for 3:

### Probability Distribution if the Prediction is 0:

Current value:

| | 0 | 1 | 2 | 3 |
|---|---|---|---|---|
| Percentage: | 65% | 15% | 12% | 8% |

Probability Distribution if the Prediction is 3, after the Actual Value has been Mirrored:

Current value:

| | 0 | 1 | 2 | 3 |
|---|---|---|---|---|
| Percentage: | 68% | 12% | 11% | 9% |

### Probability Distribution Used for 0 and Mirrored 3:

Current value:

| | 0 | 1 | 2 | 3 |
|---|---|---|---|---|
| Percentage: | 66.5% | 13.5% | 11.5% | 8.5% |

The entropy for this probability distribution equals H(p)=(−((0.665*ln(0.665))+(0.135*ln(0.135))+(0.115*ln(0.115))+(0.085*ln(0.085))))/ln(2)=1.44253959. If instead the individual probability distributions would have been used, the entropy when the prediction is 0 would be (−((0.65*ln(0.65))+(0.15*ln(0.15))+(0.12*ln(0.12))+(0.08*ln(0.08))))/ln(2)=1.47308802, and the entropy for when the prediction is 1 would be (−((0.68*ln(0.68))+(0.12*ln(0.12))+(0.11*ln(0.11))+(0.09*ln(0.09))))/ln(2)=1.40835523. If both 0 and 3 were equally probable, the average bit rate would, in steady state, be equal to (1.40835523+1.47308802)/2=1.44072163. This is slightly less than 1.44253959, which means that some compression efficiency is lost by combining the two distributions using mirroring. However, the new, combined probability distribution will converge twice as fast, which means that for short sequences (small images), it may be more efficient in terms of bit rate.

It is also possible to use a mirrored, shared context in the beginning of the compression to get a good convergence speed for the probability distribution estimates, and later, when the convergence is no longer an issue, start using separate contexts for decreased steady-state rate.

A person skilled in the art will also understand that it is also possible to use fixed probability distributions that are not estimated during the compression/decompression. These fixed values can be estimated once for all and then hard-coded in the encoder/decoder. Likewise it is also possible to use other entropy coders than arithmetic coders to compress the data. Huffman coders, Golomb-Rice and other variable bit rate coders can be used, so can Tunstall coders.

Of course it is possible to use a more elaborate predictor than just taking the color of the pixel to the left. One example is described in the pseudo code below. Here, left is the pixel immediately to the left, upper is the pixel immediately above, and diag is the pixel one step up and one step to the left. The array pred_col[3] holds the red, green and blue components of the predicted pixel. Likewise the arrays upper[3] holds the red, green and blue components of the ‘upper’ pixel, and the same notation goes for ‘diag’ and ‘left’.

```
if(abs(abs(diag[1] − upper[1]) − abs(diag[1] − left[1])) < 4
&& abs(diag[1] − upper[1]) < 4)
{
// There is a very small difference between upper, left and
// diag. Use planar model to predict.
pred_col[0] = CLAMP(0, left[0] + upper[0] − diag[0], 255);
pred_col[1] = CLAMP(0, left[1] + upper[1] − diag[1], 255);
pred_col[2] = CLAMP(0, left[2] + upper[2] − diag[2], 255);
}
elseif(abs(abs(diag[1]−upper[1]) − abs(diag[1]−left[1])) < 10)
{
// There is a very small difference between upper and left.
//Use (up+left)/2 model.
pred_col[0] = CLAMP(0, ROUND((left[0] + upper[0])/2), 255);
pred_col[1] = CLAMP(0, ROUND((left[1] + upper[1])/2), 255);
pred_col[2] = CLAMP(0, ROUND((left[2] + upper[2])/2), 255);
}
else
{
if(abs(abs(diag[1]−upper[1]) − abs(diag[1]−left[1])) < 64)
{
        // There seems to be an edge here. Follow the edge.
        if(abs(diag[1] − upper[1]) < abs(diag[1] − left[1]))
        {
            pred_col[0] = ROUND((3*left[0] + upper[0])/4.0);
            pred_col[1] = ROUND((3*left[1] + upper[1])/4.0);
            pred_col[2] = ROUND((3*left[2] + upper[2])/4.0);
        }
        else
        {
            pred_col[0] = ROUND((left[0] + 3*upper[0])/4.0);
            pred_col[1] = ROUND((left[1] + 3*upper[1])/4.0);
            pred_col[2] = ROUND((left[2] + 3*upper[2])/4.0);
        }
}
else
{
        // There seems to be an edge here. Follow the edge.
        if(abs(diag[1] − upper[1]) < abs(diag[1] − left[1]))
        {
            pred_col[0] = left[0];
            pred_col[1] = left[1];
            pred_col[2] = left[2];
        }
        else
        {
            pred_col[0] = upper[0];
            pred_col[1] = upper[1];
            pred_col[2] = upper[2];
        }
}
}
```

Here && denotes the logical AND operation, and CLAMP(0,x,255) maps negative x-values to 0 and x-values larger than 255 to 255, whereas x-values in the interval [0,255] are unaffected.

The reasoning behind this way of creating the prediction of the current color is as follows: If there are very small differences between left, upper and diag, then the patch is likely smooth and a planar prediction (left+upper-diag) will give a good result.

If the data is slightly more complex, but left and upper are still very similar, it makes sense to use the average of these (left+upper)/2 as a predictor.

Finally, if there is not a good agreement at all between left and upper, it can be assumed that there is an edge going through the block. If diag and upper are very similar, there might be a line going through them, and then perhaps there is a line between the left pixel and the pixel we are trying to predict as well. In this case the left pixel should be used as the predictor (last segment of code).

However, if the difference between the upper and the left is not too big, it may be better to use (3*left+upper)/4 as the predictor (second last segment of code).

Note that the decision is taken by only investigating the green component. More elaborate decision rules may involve all three components.

Of course many other predictors can be used.

According to a further embodiment said parameter is a modifier table value. The at least one previously transmitted additional parameter comprises flip bit information and base color. Hence, the modifier table value, i.e. the number of the modifier table, is encoded by using the previously transmitted additional parameters: flip bit and base color. Since the values obtained from the modifier table affects the entire half block, all eight pixels in the half-block must be predicted. I.e. the entire half block is the area of the texture block to be encoded that is affected by the parameter which in this case is the modifier table value.

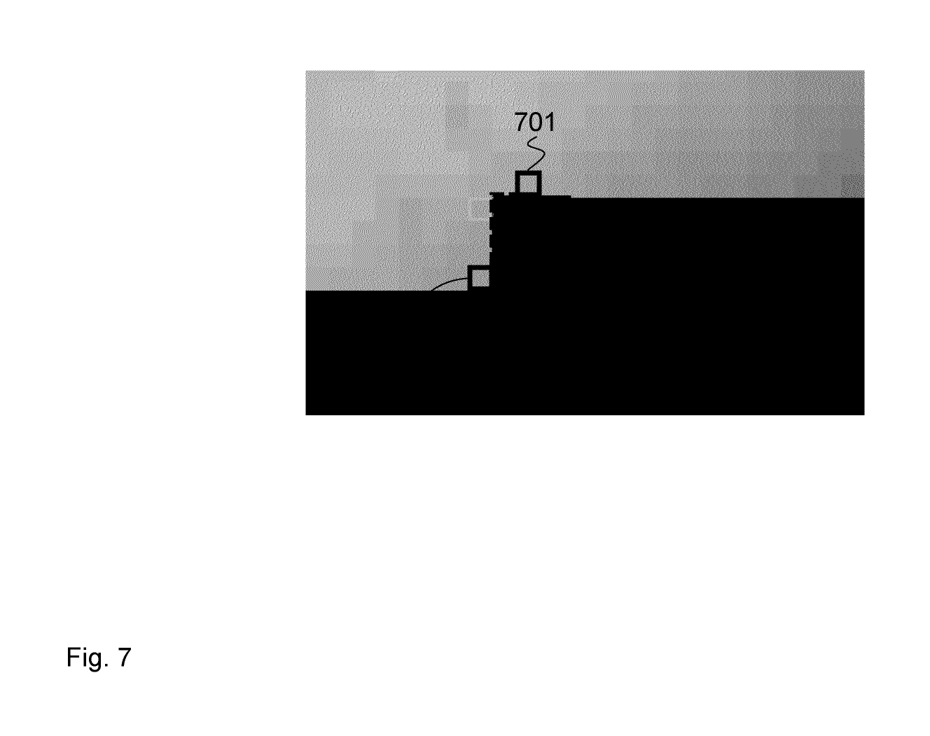

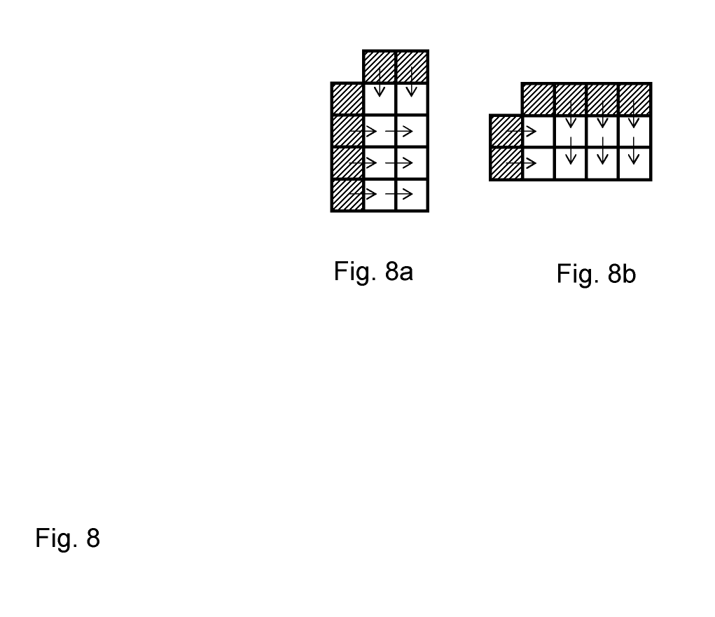

This is illustrated in FIG. 7; all pixels in the half block 700 are predicted. For instance, pixel 702 may be predicted by copying the color in pixel 701, and pixel 702 may be predicted by copying the color of pixel 703. FIG. 8 shows an example how prediction of pixels can be made for a standing half block (FIG. 8a) and a lying half block (FIG. 8b). The arrows indicate how the pixels are predicted, i.e. which pixels that are used to predict other pixels. To know which configuration (lying or standing) to use, the already sent flip bit is used. The flip bit indicates whether the half block has a lying or a standing configuration. This is a non-limiting example; it is also possible to use several pixels outside the half block to predict a pixel within the half block, and it is also possible to use other pixels than the ones marked with hatched pattern in FIG. 8 for prediction.

Typically the base color for the half block has already been sent by the encoder (or decoded by the decoder). Hence the base color information is available and can be used in the prediction of the modifier table value. The predicted pixels are now compressed, testing all eight possible values of the modifier table value. For each modifier table index, the pixels are decompressed, and the error between the decompressed version of the predicted pixels and the predicted pixels is measured. The modifier table index that gives the smallest error is now selected as our prediction of the modifier table index.

Another embodiment of the present invention is a way to compress the pixel indices in S3TC using the already transmitted two base colors col0 and col1. As illustrated in FIG. 6, the color of the corresponding pixel 602 is first predicted by using one or more already transmitted pixels 601. Then the four possible pixel index values are tried, and the color for the corresponding pixel 602 is calculated using the ordinary s3tc rules:

If pixel index = 00,
col = col0
If pixel index = 01,
col = col1
If pixel index = 10
col = (2/3) col0 + (1/3) col1
If pixel index = 11
col = (1/3) col0 + (2/3) col1

Now find the value of the pixel index that generates a col value that is closest to the prediction index. Note that this is equivalent to compressing and decompressing the predicted pixel value using the four different pixel index values, and selecting as the predicted pixel index value the pixel index that minimizes the error between the predicted pixel value and the decompressed pixel value.

The predicted pixel index is now used to transmit the actual pixel index.

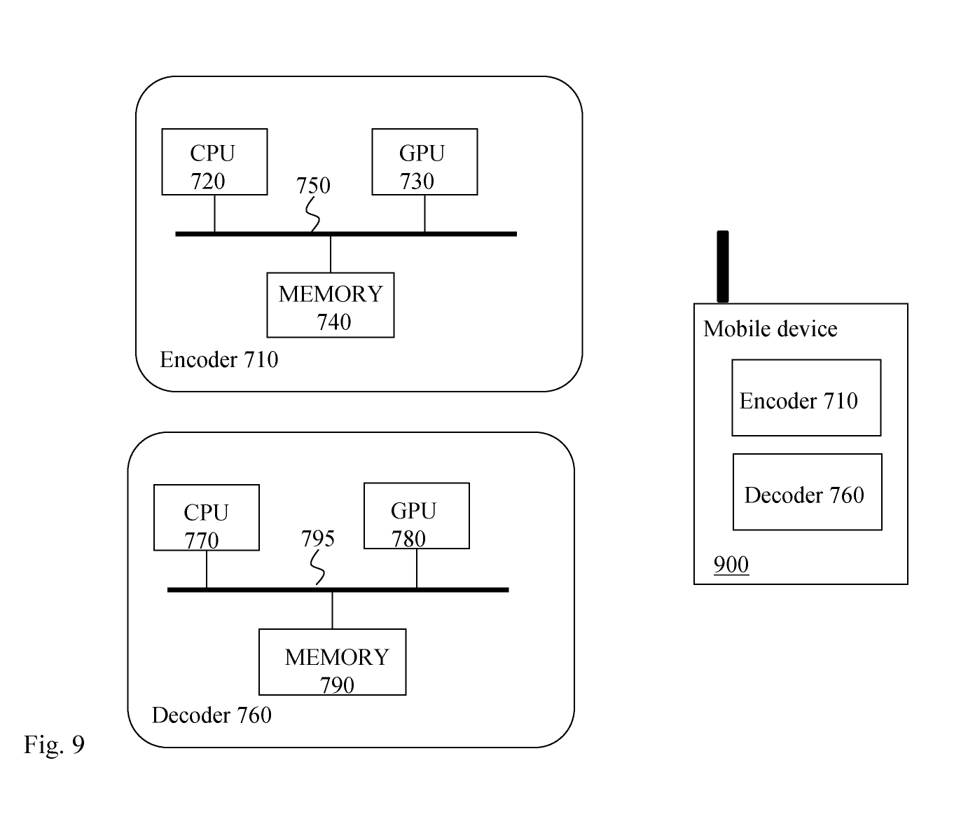

The above mentioned steps may be performed by a processor such as a Central Processing Unit (CPU) 720;770 or a Graphics Processing Unit (GPU) 730;780. The processor may be used in an encoder 710 and in a decoder 760 as illustrated in FIG. 9. Typically, the encoder and the decoder, respectively also comprises a memory 740;790 for storing textures and other associated information. The memory may further store instructions for performing the functionalities of the processor. For each functionality that the processor is configured to perform, a corresponding instruction is retrieved from the memory such that the instruction can be executed by the processor. The memory and the processor(s) is/are connected by a bus 750;795. Moreover, FIG. 9 also illustrates schematically a mobile device comprising the encoder and/or the decoder according to embodiments of the present invention.

Hence, an encoder 710 for encoding a parameter associated with at least one pixel of a texture block to be encoded is provided. The encoder 710 comprises a processor 720;730 configured to predict a value of at least one pixel in an area of the texture block to be encoded that is affected by the parameter by using at least one previously encoded pixel. It should be noted that the processor 720;730 either may comprise a CPU 720 or a GPU 730 or a combination thereof. The processor 720;730 is further configured to select at least two settings of the parameter to be encoded, to calculate, for each of the at least two settings of the parameter, a difference measure between said predicted value of said at least one pixel and a value representing said at least one pixel as if the at least one pixel would have been encoded and decoded with the setting of the parameter by using at least one previously transmitted additional parameter. Moreover, the processor 720;730 is configured to select the setting of the parameter that minimizes said difference measure, and to use the selected setting of said parameter to encode said parameter.

According to embodiments, said parameter is a pixel index and the at least one previously transmitted additional parameter comprises at least one base color and at least one modifier table index.

According to other embodiments, said parameter is a modifier table index and the at least one previously transmitted additional parameter flip bit information and base color.

The processor 720;730 may be further configured to encode said at least one pixel with one of the at least two settings of the parameter and decoding said at least one pixel with one of the at least two settings of the parameter to get a value representing said at least one pixel by using at least one previously transmitted additional parameter.

Accordingly, a decoder 760 for decoding a parameter associated with at least one pixel of a texture block to be decoded is provided. The decoder 760 comprises a processor 770;780 configured to predict a value of at least one pixel in an area of the texture block to be decoded that is affected by the parameter by using at least one previously decoded pixel and to select at least two settings of the parameter to be decoded, to calculate, for each of the at least two settings of the parameter, a difference measure between said predicted value of said at least one pixel and a value representing said at least one pixel as if the at least one pixel would have been encoded and decoded with the setting of the parameter by using at least one previously transmitted additional parameter. The decoder 770;780 is further configured to select the setting of the parameter that minimizes said difference measure, and to use the selected setting of said parameter to decode said parameter. It should be noted that the processor 770;780 either may comprise a CPU 770 or a GPU 780 or a combination thereof.

According to embodiments, said parameter is a pixel index and the at least one previously transmitted additional parameter comprises at least one base color and at least one modifier table index.

According to other embodiments, said parameter is a modifier table index and the at least one previously transmitted additional parameter flip bit information and base color.

The processor 770;780 may further be configured to encode and decode said at least one pixel with one of the at least two settings of the parameter to get a value representing said at least one pixel by using at least one previously transmitted additional parameter.

1-32. (canceled)

33. A method in an encoder for encoding a parameter associated with at least one pixel of a texture block to be encoded, the method comprising:
predicting a value of at least one pixel in an area of the texture block to be encoded that is affected by the parameter, by using at least one previously encoded pixel;
selecting at least two settings of the parameter to be encoded;
calculating, for each of the at least two settings of the parameter, a difference measure between said predicted value of said at least one pixel and a value representing said at least one pixel as if the at least one pixel would have been encoded and decoded with the setting of the parameter by using at least one previously transmitted additional parameter;
selecting the setting of the parameter that minimizes said difference measure; and
using the selected setting of said parameter to encode said parameter.

34. The method of claim 33, where said parameter is a pixel index.

35. The method of claim 34, wherein the at least one previously transmitted additional parameter comprises at least one base color and at least one modifier table value.

36. The method of claim 33, wherein said parameter is a modifier table value.

37. The method of claim 36, wherein the at least one previously transmitted additional parameter comprises flip bit information and base color.

38. The method of claim 33, wherein calculating the difference measure further comprises encoding said at least one pixel with one of the at least two settings of the parameter and decoding said at least one pixel with one of the at least two settings of the parameter to get a value representing said at least one pixel by using at least one previously transmitted additional parameter.

39. The method of claim 33, where said difference measure is a summed squared difference.

40. The method of claim 33, where said difference measure is a summed absolute difference.

41. A method in a decoder for decoding a parameter associated with at least one pixel of a texture block to be decoded, the method comprising:
predicting a value of at least one pixel in an area of the texture block to be decoded that is affected by the parameter by using at least one previously decoded pixel;
selecting at least two settings of the parameter to be decoded;
calculating, for each of the at least two settings of the parameter, a difference measure between said predicted value of said at least one pixel and a value representing said at least one pixel as if the at least one pixel would have been encoded and decoded with the setting of the parameter by using at least one previously transmitted additional parameter;
selecting the setting of the parameter that minimizes said difference measure; and
using the selected setting of said parameter to decode said parameter.

42. The method of claim 41, where said parameter is a pixel index.

43. The method of claim 42, wherein the at least one previously transmitted additional parameter comprises at least one base color and at least one modifier table value.

44. The method of claim 41 wherein said parameter is a modifier table value.

45. The method of claim 44, wherein the at least one previously transmitted additional parameter comprises flip bit information and base color.

46. The method of claim 41, wherein calculating the difference measure further comprises encoding and decoding said at least one pixel with one of the at least two settings of the parameter to get a value representing said at least one pixel by using at least one previously transmitted additional parameter.

47. The method of claim 40, where said difference measure is a summed squared difference.

48. The method of claim 40, where said difference measure is a summed absolute difference.

49. An encoder for encoding a parameter associated with at least one pixel of a texture block to be encoded, the encoder comprising a processor configured:
to predict a value of at least one pixel in an area of the texture block to be encoded that is affected by the parameter by using at least one previously encoded pixel;
to select at least two settings of the parameter to be encoded;
to calculate, for each of the at least two settings of the parameter, a difference measure between said predicted value of said at least one pixel and a value representing said at least one pixel as if the at least one pixel would have been encoded and decoded with the setting of the parameter by using at least one previously transmitted additional parameter;
to select the setting of the parameter that minimizes said difference measure; and
to use the selected setting of said parameter to encode said parameter.

50. The encoder of claim 49, where said parameter is a pixel index.

51. The encoder of claim 50, wherein the at least one previously transmitted additional parameter comprises at least one base color and at least one modifier table value.

52. The encoder of claim 49, wherein said parameter is a modifier table value.

53. The encoder of claim 52, wherein the at least one previously transmitted additional parameter comprises flip bit information and base color.

54. The encoder of claim 49, wherein the processor is further configured to encode said at least one pixel with one of the at least two settings of the parameter and decoding said at least one pixel with one of the at least two settings of the parameter to get a value representing said at least one pixel by using at least one previously transmitted additional parameter.

55. A decoder for decoding a parameter associated with at least one pixel of a texture block to be decoded comprising a processor configured:
to predict a value of at least one pixel in an area of the texture block to be decoded that is affected by the parameter by using at least one previously decoded pixel;
to select at least two settings of the parameter to be decoded;
to calculate, for each of the at least two settings of the parameter, a difference measure between said predicted value of said at least one pixel and a value representing said at least one pixel as if the at least one pixel would have been encoded and decoded with the setting of the parameter by using at least one previously transmitted additional parameter;
to select the setting of the parameter that minimizes said difference measure; and
to use the selected setting of said parameter to decode said parameter.

56. The decoder of claim 55, where said parameter is a pixel index.

57. The decoder of claim 56, wherein the at least one previously transmitted additional parameter comprises at least one base color and at least one modifier table value.

58. The decoder of claim 55 wherein said parameter is a modifier table value.

59. The decoder of claim 58, wherein the at least one previously transmitted additional parameter comprises flip bit information and base color.

60. The decoder of claim 55, wherein the processor is further configured to encode and decode said at least one pixel with one of the at least two settings of the parameter to get a value representing said at least one pixel by using at least one previously transmitted additional parameter.

61. The decoder of claim 55, where said difference measure is a summed squared difference.

62. The decoder of claim 55, where said difference measure is a summed absolute difference.

63. A mobile device comprising the encoder of claim 49.

64. A mobile device comprising the decoder of claim 55.
